(19) United States
(12) Patent Application Publication
(10) Pub. No.: US 2016/0357612 A1
(43) Pub. Date: Dec. 8, 2016

(54) DISTRIBUTED STREAM PROCESSING SERVICES MERGING METHOD AND APPARATUS THEREOF

(71) Applicant: Electronics and Telecommunications Research Institute, Daejeon (KR)

(72) Inventors: Myung-Cheol LEE, Daejeon (KR); Mi-Young LEE, Daejeon (KR)

(21) Appl. No.: 15/153,264

(22) Filed: May 12, 2016

(30) Foreign Application Priority Data
Jun. 2, 2015 (KR) 10-2015-0078030

(51) Int. Cl. G06F 9/50; G06F 17/30

(52) U.S. Cl. CPC G06F 9/5083; G06F 17/30327; G06F 17/30516

(57) ABSTRACT

The following description relates to a method and an apparatus for merging distributed stream processing services. A method for merging distributed stream processing services according to an example includes generating a global service tree based on one distributed stream processing service; when a new distributed stream processing service different from the one distributed stream processing service is inputted, generating an individual service tree for the new distributed stream processing service; and updating the global service tree by merging at least one node commonly existing in both the global service tree and the individual service tree. Common resources may be allocated to tasks (or instances) existing commonly in distributed stream processing services.

### CROSS REFERENCE TO RELATED APPLICATION

This application claims the benefit under 35 USC §119 A of Korean Patent Application No. 10-2015-0078030, filed on Jun. 2, 2015, with the Korean Intellectual Property Office, the entire disclosure of which is incorporated herein by reference for all purposes.

### BACKGROUND

1. Field

The following description relates to a method and an apparatus for merging distributed stream processing services.

2. Description of Related Art

Demand for processing various stream data in real time became crucial in a big data era. A method of distributed parallel processing has been used to process stream data in real time in distributed network environments.

FIG. 1 is a diagram illustrating an example of a conventional method for distributed processing stream data based on data flow.

A distributed stream processing service 100 includes an input source 10 to which stream data is inputted and an output source 20 through which processing result is outputted.

A process for processing stream data is described by tasks 111, 112, 113, 114, and 115 describing queries or processing methods related to stream data, and directed acyclic graph (DAG) which describes data flow between the tasks 111, 112, 113, 114, and 115.

The tasks 111, 112, 113, 114, and 115 in the distributed stream processing service 100 may be divided into more than two instances 131, 132, 133, 134, and 135 and the divided instances 131, 132, 133, 134, and 135 may be distributed into more than two distributed nodes 110, 120, 130, 140, and 150 in cluster.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following description provides a method for improving performance of large-scale distributed stream processing services.

The following description provides a method for performing large-scale distributed stream processing services with less resources.

In one general aspect, a method for merging distributed stream processing services may include generating a global service tree based on one distributed stream processing service; when a new distributed stream processing service different from the one distributed stream processing service is inputted, generating an individual service tree for the new distributed stream processing service; and updating the global service tree by merging at least one node commonly existing in both the global service tree and the individual service tree.

The updating the global service tree may include determining whether there are nodes commonly existing in both the global service tree and the individual service tree by comparing with each other sequentially from each highest node of the global service tree and the individual service tree.

The determining whether there are nodes commonly existing in both the global service tree and the individual service tree may include determining whether there are a series of common nodes starting from the highest node.

The updating the global service tree may include: determining the lowest node of the series of common nodes as a merging reference node; and adding a subtree connected under the merging reference node in the individual service tree to under the merging reference node of the global service tree.

The method may further include, when a request for deleting any one distributed stream processing service among the distributed stream processing services reflected to the global service tree is made, updating the global service tree by deleting the node, which is used only for the distributed stream processing service requested to be deleted, from the global service tree.

The method may further include setting a reference count for each node in the global service tree, the reference count representing how many distributed stream processing services use the node.

The method may further include, when there is a node of which the reference count is equal to a predetermined value or above, connecting any one subtree among the subtrees connected under the corresponding node to the upper node of the corresponding node.

The method may further include, when a request for deleting a distributed stream processing service among the distributed stream processing services reflected to the global service tree is made, updating the global service tree by deleting the node which is used only for the corresponding distributed stream processing service from the global service tree.

The deleting the node from the global service tree may include: comparing with each other sequentially from each highest node of the global service tree and an individual service tree for the distributed stream processing service tree requested to be deleted; when there is a common node of which the reference count is 1, deleting the common node and a subtree connected under the common node; and when there is a common node of which the reference count is 2 or above, reducing the reference count of the common node by 1.

The method may further include distributing the subtrees in the updated global service tree to different servers.

In another general aspect, an apparatus for merging distributed stream processing services may include a global service tree manager configured to generate a global service tree based on one distributed stream processing service, generate an individual service tree for a new distributed stream processing service when the new distributed stream processing service different from the one distributed stream processing service is inputted, and update the global service tree by merging at least one node commonly existing in both the global service tree and the individual service tree; and a scheduler configured to perform resource allocation based on the updated global service tree.

The global service tree manager may compare with each other sequentially from each highest node of the global service tree and the individual service tree to determine whether there are nodes commonly existing in both the global service tree and the individual service tree.

The global service tree manager may determine whether there are a series of common nodes starting from the highest node.

The global service tree manager may determine the lowest node of the series of common nodes as a merging reference node; and add a subtree connected under the merging reference node in the individual service tree to under the merging reference node of the global service tree.

When a request for deleting any one distributed stream processing service among the distributed stream processing services reflected to the global service tree is made, the global service tree manager may update the global service tree by deleting the node, which is used only for the distributed stream processing service requested to be deleted, from the global service tree.

The global service tree manager may set a reference count for each node in the global service tree, the reference count representing how many distributed stream processing services use the node.

When there is a node of which the reference count is equal to a predetermined value or above, the global service tree manager may connect any one subtree among the subtrees connected under the corresponding node to the upper node of the corresponding node.

When a request for deleting a distributed stream processing service among the distributed stream processing services reflected to the global service tree is made, the global service tree manager may update the global service tree by deleting the node, which is used only for the corresponding distributed stream processing service, from the global service tree.

The global service tree manager may compare with each other sequentially from each highest node of the global service tree and an individual service tree for the distributed stream processing service tree requested to be deleted, The global service tree manager may delete a common node of which the reference count is 1 and a subtree connected under the common node when there is the common node of which the reference count is 1, and reduce the reference count of a common node of which the reference count is 2 or above by 1 when there is the common node of which the reference count is 2 or above.

The scheduler may distribute the subtrees in the updated global service tree to different servers.

Common resources may be allocated to tasks (or instances) existing commonly in distributed stream processing services.

The following description provides a method for improving performance of large-scale distributed stream processing services.

Other features and aspects will be apparent from the following detailed description, the drawings, and the claims.

### BRIEF DESCRIPTION OF THE DRAWINGS

FIG. 1 is a diagram illustrating an example of a conventional method for distributed processing stream data based on data flow.

FIG. 2A and FIG. 2B are diagrams illustrating an example of a method for merging distributed stream processing services.

FIG. 3 is a diagram illustrating an example for explaining a stream data distribution processing system.

FIG. 4 is a flowchart illustrating an example of a method for merging distributed stream processing services.

FIG. 5A, FIG. 5B, FIG. 5C and FIG. 5D are diagrams illustrating an example of a method for merging distributed stream processing services.

FIG. 6A and FIG. 6B are diagrams illustrating an example of a task distribution arrangement method based on a global service tree.

FIG. 7A and FIG. 7B are diagrams illustrating an example of a method for modifying a subtree in a global service tree.

FIG. 8 is a flowchart illustrating an example of a method for deleting a distributed stream processing service from a global service tree.

FIG. 9A and FIG. 9B are diagrams illustrating an example of a method for deleting a distributed stream processing service from a global service tree.

FIG. 10 is a diagram illustrating examples of global service trees for each user.

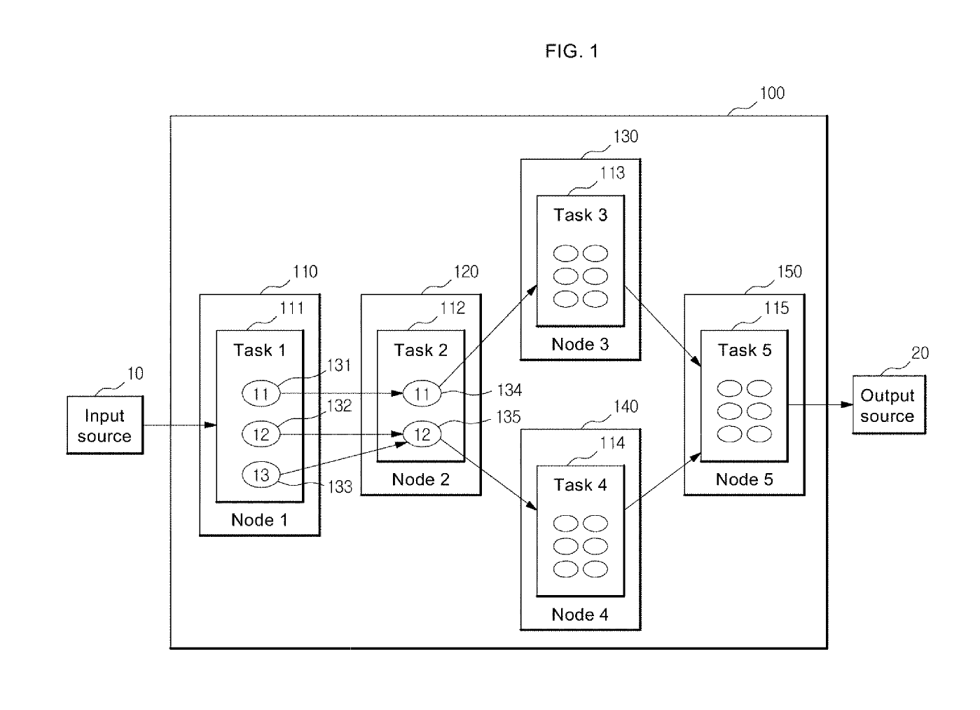

Throughout the drawings and the detailed description, unless otherwise described or provided, the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure is thorough, complete, and conveys the full scope of the disclosure to one of ordinary skill in the art.

It will be understood that, although the terms “first,” “second,” “third,” “fourth” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. Similarly, when it is described that a method includes series of steps, a sequence of the steps is not a sequence in which the steps should be performed in the sequence, an arbitrary technical step may be omitted and/or another arbitrary step, which is not disclosed herein, may be added to the method.

The terms used herein may be exchangeable to be operated in different directions than shown and described herein under an appropriate environment. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

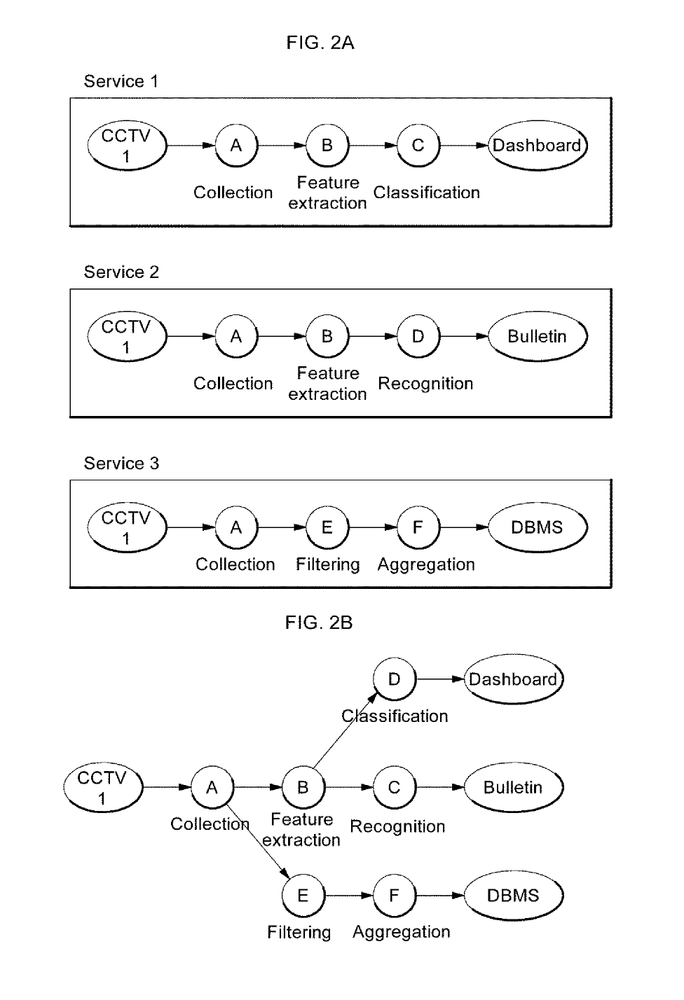

FIG. 2A and FIG. 2B are diagrams illustrating an example of a method for merging distributed stream processing services.

FIG. 2A is a diagram illustrating examples of distributed stream processing services (service 1, service 2, service 3) which process stream data (for example, visual data) being generated continuously in large quantities from CCTVs.

As shown in FIG. 2A, it is assumed that distributed stream processing services include a common input source (CCTV 1) and common tasks (for example, collection and feature extraction). In this case, when each distributed stream processing service is independently processed, unnecessary redundancy resources are consumed for processing the same tasks.

When the same resources are allocated to the tasks (or the input source or the output source) commonly existing in distributed stream processing services, stream data may be processed with less resources and less cost.

FIG. 2B is a diagram illustrating an example of a global service tree which is generated by merging an input source (CCTV1) and tasks (collection and feature extraction) commonly existing in multiple distributed stream processing services.

When stream data is processed according to the global service tree illustrated in FIG. 2B, stream data may be processed with less resources and less processing time, compared to those when the distributed stream processing services are processed individually as illustrated in FIG. 2A.

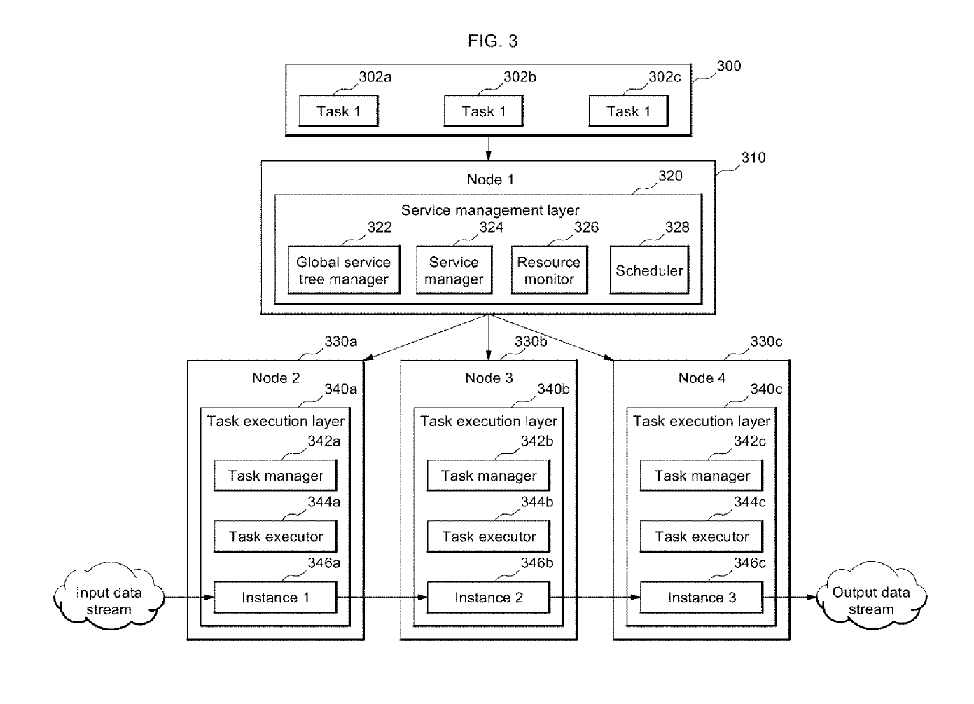

FIG. 3 is a diagram illustrating an example for explaining a stream data distribution processing system. At least one of elements illustrated in FIG. 3 can be omitted.

Referring to FIG. 3, a stream data distribution processing system according to an example may include a service management layer 320 and at least one task execution layers 340a, 340b, and 340c.

The service management layer 320 may be arranged in distributed nodes 330a, 330b, and 330c in which the task execution layers 340a, 340b, and 340c are arranged or arranged in a separate distributed node 310 in which the task execution layers 340a, 340b, and 340c are not arranged. The task execution layers 340a, 340b, and 340c may be arranged in distributed nodes 330a, 330b, and 330c, respectively.

The service management layer 320 may be called as an apparatus for merging distributed stream processing services. The service management layer 320 may include a global service tree manager 322, a service manager 324, a resource monitor 326, and a scheduler 328.

The global service tree manager 322 may manage a global service tree. Managing a global service tree may include, for example, generating/maintaining a global service tree, adding a task node in the global service tree, deleting a task node from the global service tree, and the like.

When a request for registering a new distributed stream processing service is made by the service manager 324, the global service tree manager 322 may generate an individual service tree for the corresponding distributed stream processing service and reflect the generated individual service tree into the global service tree. When a request for deleting a distributed stream processing service is made by the service manager 324, the global service tree manager 322 may delete a task node for the corresponding distributed stream processing service from the global service tree.

The service manager 324 may process user's requests, for example, such as registration, deletion and search of the distributed stream processing service 300.

The resource monitor 326 may periodically collect at least one of input load, output load, and data processing performance information according to instances and resource use status information according to distributed nodes through the task executors 344a, 344b, and 344c. The resource monitor 326 may also build information for task (or instance) rearrangement based on the collected information.

The resource monitor 326 may monitor and analyze trend of performance of the distributed stream processing services. The resource monitor 326 may determine re-scheduling of the distributed stream processing services or the tasks (or instances). The resource monitor 326 may request for re-scheduling based on the determination to the scheduler 328. When a request for re-scheduling a task from the task executors 344a, 344b, and 344c, the resource monitor 326 may transmit the request to the scheduler 328.

When a request for arranging the task (or instance) is received from the service manager 324 or a request for re-scheduling the distributed stream processing services or the task (or instance) is made from the resource monitor 326, the scheduler 328 may perform scheduling based on the request. The scheduler 328 may select a distributed node having a spare resource based on resource information of the distributed nodes which are managed by the resource monitor 326, and allocate one or more tasks (or instances) to the task execution layer in which the selected distributed node is located.

The task execution layers 340a, 340b, and 340c may include task managers 342A, 342B, and 342c and task executors 344a, 344b, and 344c.

The task managers 342A, 342B, and 342c may execute threads generated from the task executors 344a, 344b, and 344c, and control and manage the task executors 344a, 344b, and 344c. The scheduler 328 may allocate a task (or instance) to the task executors 344a, 344b, and 344c. The allocated task (or instance) may bind to input data stream or output data stream. The task executors 344a, 344b, and 344c may execute the task (or instance) as an independent thread and periodically collect status of tasks (or instances) which are executing.

The distributed stream processing services 300 may include at least one task 302a, 302b, 302c. A flow of inputs/outputs of stream data exist between the tasks 302a, 302b, and 302c. Each of the tasks 302a, 302b, and 302c may be divided for execution into one or more instances 346a, 346b, and 346c. The distributed stream processing services 300 may be divided into task units (or instance units) and allocated to the distributed nodes 330a, 330b, and 330c for execution by the service management layer 320 and the task execution layers 340a, 340b, and 340c.

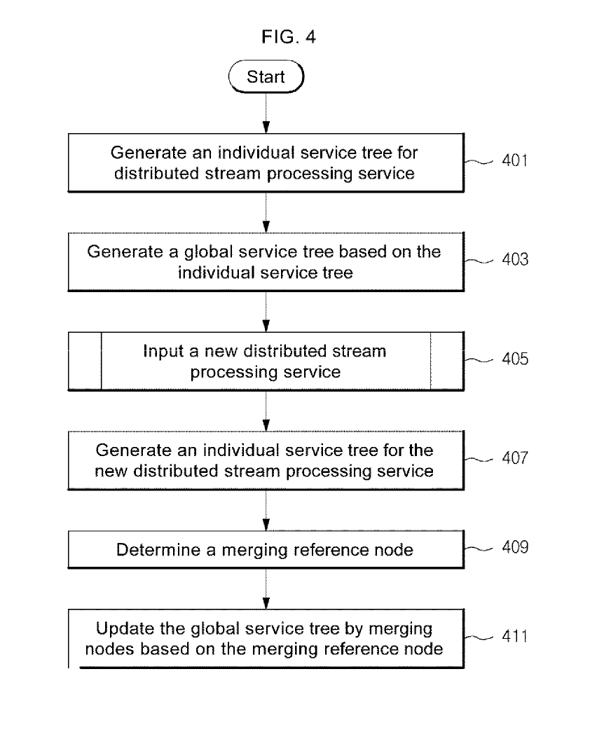

FIG. 4 is a flowchart illustrating an example of a method for merging distributed stream processing services. At least one of the steps illustrated in FIG. 4 can be omitted.

In step 401, the apparatus for merging distributed stream processing services may analyze structure of a distributed stream processing service which is requested for registration (or execution) and generate an individual service tree for the corresponding distributed stream processing service.

The distributed stream processing service may include at least one input source, at least one task and at least one output source. The individual service tree may be described by at least one node and flow between the nodes. Each node in the individual service tree may be corresponded to any one of the input source, the task (or instance) and the output source. The individual service tree may be stored in a service tree list for deleting or modifying the corresponding distributed stream processing service.

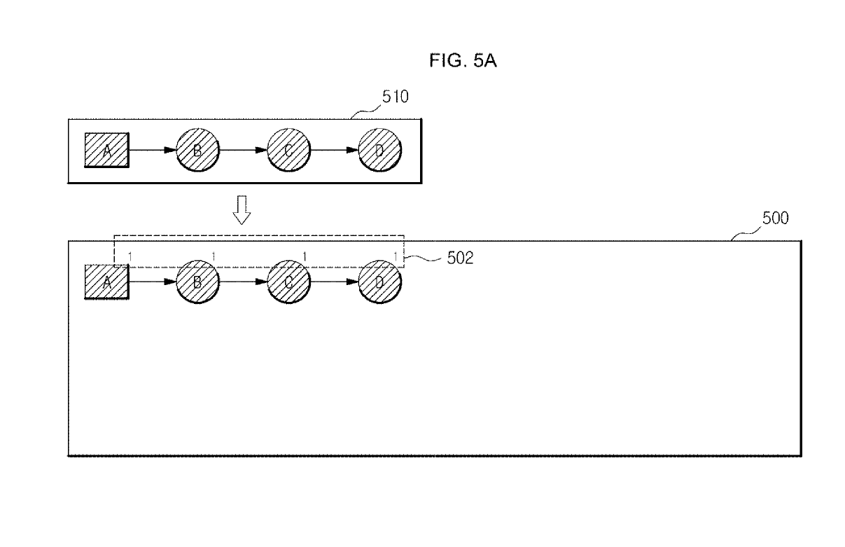

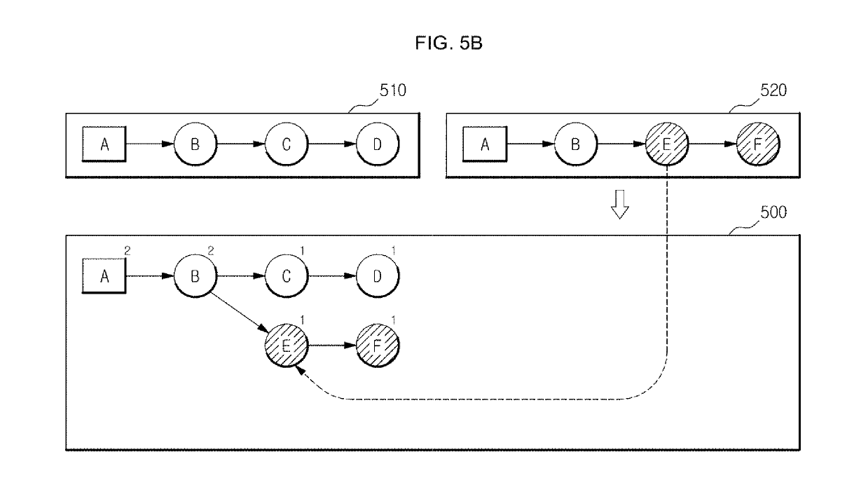

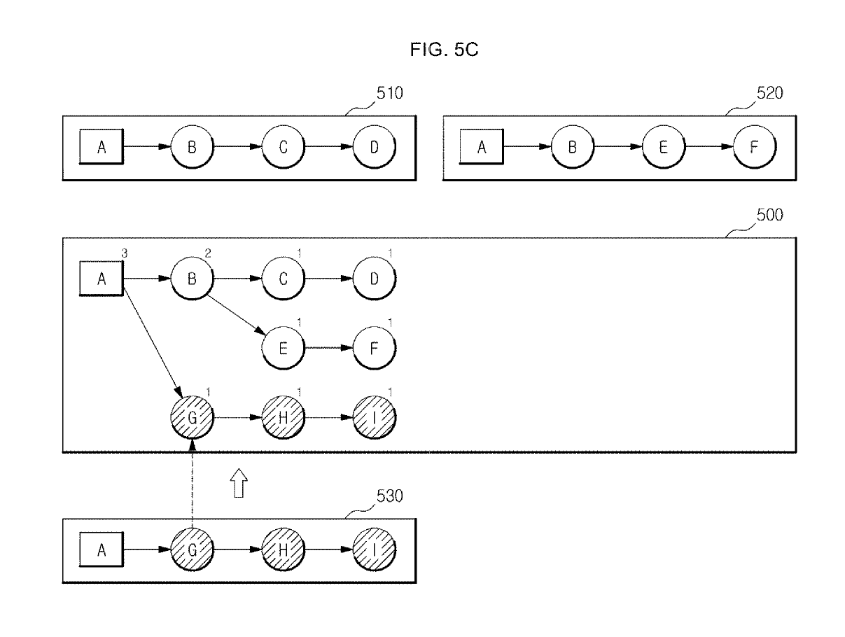

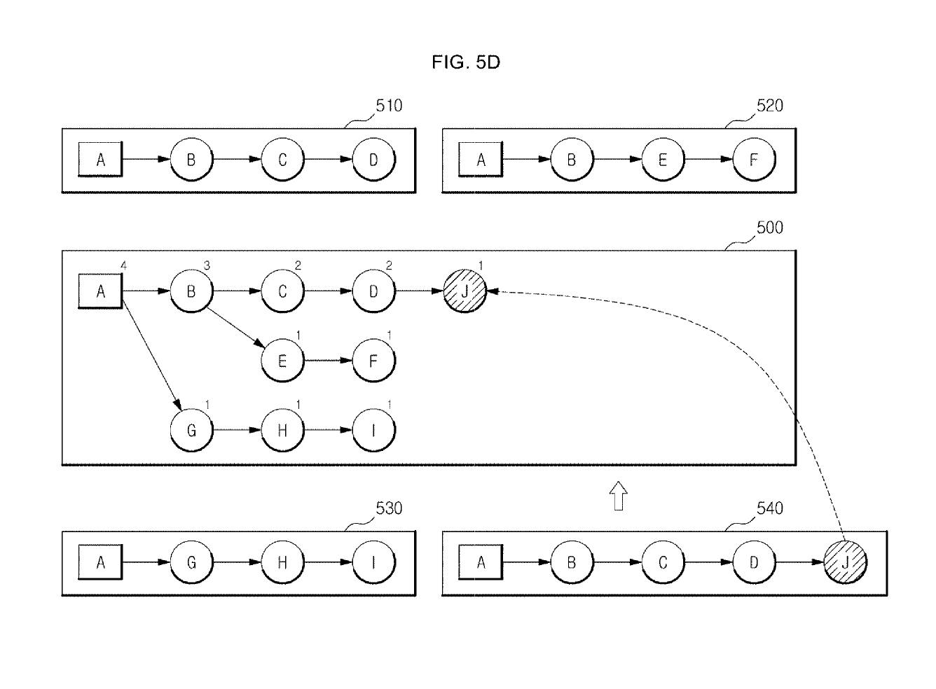

In step 403, the apparatus for merging distributed stream processing services may generate a global service tree based on the individual service tree generated in step 401. Examples of an individual service tree and a global service tree generated based on the individual service tree are illustrated in FIG. 5A. In FIG. 5A, it is assumed that an individual service tree 510 includes an input source A and a series of tasks B, C, and D. In this case, a global service tree 500 may be described by the input source A and flow of the tasks B, C, and D like the individual service tree 510.

Reference count 502 for each node A, B, C, and D may be set. The reference count 502 may represent how many distributed stream processing services use the each node A, B, C, and D. When the global service tree is initially generated, the reference count 502 of each node may be set as “1”. The reference count may be used to delete a distributed stream processing service from the global service tree. This will be explained in detail below.

In step 405, a new distributed stream processing service may be registered (or executed). Here, it is assumed that the new distributed stream processing service includes the input source A and a series of tasks B, E, and F.

In step 407, the apparatus for merging distributed stream processing services may generate an individual service tree only for the new distributed stream processing service. FIG. 5B illustrates an example of an individual service tree 520 composed of nodes corresponding to the input source A and the series of tasks B, E, and F.

In step 409, the apparatus for merging distributed stream processing services may determine a merging reference node. The merging reference node may mean a reference node to merge the nodes in the global service tree and the nodes in the individual service tree. In order to determine the merging reference node, a search may be performed from each highest node of the global service tree and the individual service tree. The highest node may be the node at the most front among the series of nodes.

For example, as shown in FIG. 5B, it is assumed that the global service tree includes nodes A, B, C, and D and the new individual service tree includes nodes A, B, E, and F. Here, the merging reference node may be determined by comparing the nodes from the highest node of the global service tree and the individual service tree. For example, it determines whether the highest node in the global service tree and the highest node in the individual service tree are a common node or not. Here, the determining a common node may mean determining whether the node is a node corresponding to an identical input source or an identical task (or instance).

Since the highest node A of the global service tree and the highest node A of the individual service tree are common, the apparatus for merging distributed stream processing services may compare the second highest node. Since the second highest node B of the global service tree and the second highest node B of the individual service tree are common, it may compare the next highest node. Since the next highest node C of the global service tree and the next highest node E of the individual service tree are not common, it may stop comparing and set the node B, which is the last node determined as the common node, as the merging reference node.

Whenever a common node is determined, the determined common node may be temporally stored. The last stored common node may be set as the merging reference node.

In step 411, the apparatus for merging distributed stream processing services may update the global service tree by merging nodes based on the merging reference node.

For example, as shown in FIG. 5B, the nodes E and F under the merging reference node B in the individual service tree 520 may be connected under the merging reference node B in the global service tree 500.

The reference count may be updated when the global service tree is updated. For example, the apparatus may increase the reference count for the merging reference node B and the upper nodes A of the merging reference node B by 1. The reference count for the lower nodes E and F newly connected under the merging reference node B may be set as “1”.

The tasks (or instances) may be then distributed based on the updated global service tree. Since the merging reference node B and the upper node A of the merging reference node B are already distributed in the distributed nodes, scheduling only for the nodes E and F under the merging reference node B may be performed.

FIG. 5C and FIG. 5D illustrate a process for updating the global service tree when it is assumed that a distributed stream processing service including the input source A and tasks G, H, and I and a distributed stream processing service including the input source A and tasks B, C, D, and J are inputted. The detailed explanation will be omitted since the process for updating the global service tree is the same as described with reference to FIG. 5B.

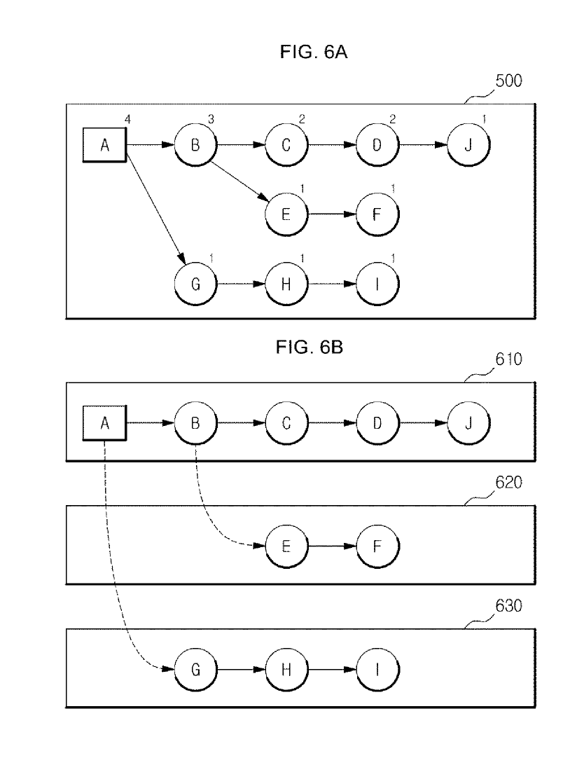

FIG. 6A and FIG. 6B are diagrams illustrating an example of a task distribution arrangement method based on a global service tree.

FIG. 6A is the global service tree generated by the method described with reference to FIG. 5A to FIG. 5D. Hereinafter, nodes in the global service tree are called as task nodes in order to avoid confusion with the distributed nodes (for example, server).

The apparatus for merging distributed stream processing services may arrange each task node into the distributed node based on the global service tree 500. The apparatus for merging distributed stream processing services may arrange a series of task nodes in the same distributed node to reduce communication loads.

For example, as shown in FIG. 6B, the apparatus for merging distributed stream processing services may arrange each of a subtree 610, a subtree 620 and a subtree 630 including a series of task nodes to distributed nodes different from each other.

The task nodes arranged in the different distributed nodes may communicate using TCP or the like, and stream data may be serialized in a byte array to be inputted/outputted. The task nodes arranged in the same distributed node may be executed by a thread of the same process and data transmission between threads may be made in a memory.

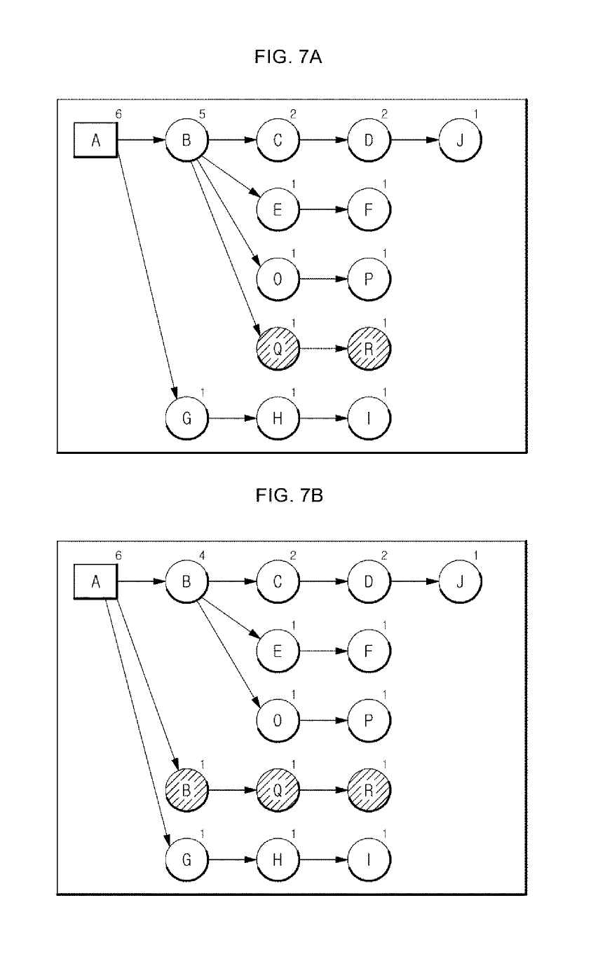

When many subtrees are branched from a node among nodes in the global service tree, overloads may be caused to the node. Thus, position of subtree may be modified to resolve the overload caused to the node. This will be explained in detail with reference to FIG. 7A and FIG. 7B.

FIG. 7A and FIG. 7B are diagrams illustrating an example of a method for modifying a subtree in a global service tree.

The reference count may be used to modify a subtree. An example for modifying a subtree when there is a node with the reference count of 5 or more will be explained with reference to FIG. 7A and FIG. 7B.

For example, as shown in FIG. 7A, it is assumed that the reference count of a node B is 5. Here, since overload may be caused to the node B, any one of subtrees under the node B may be modified to be connected to the upper node A. Here, the subtree may be modified to have a node flow of A-B-Q-R which is the same node flow of the subtree prior to the modification. The modified subtree is illustrated in FIG. 7B.

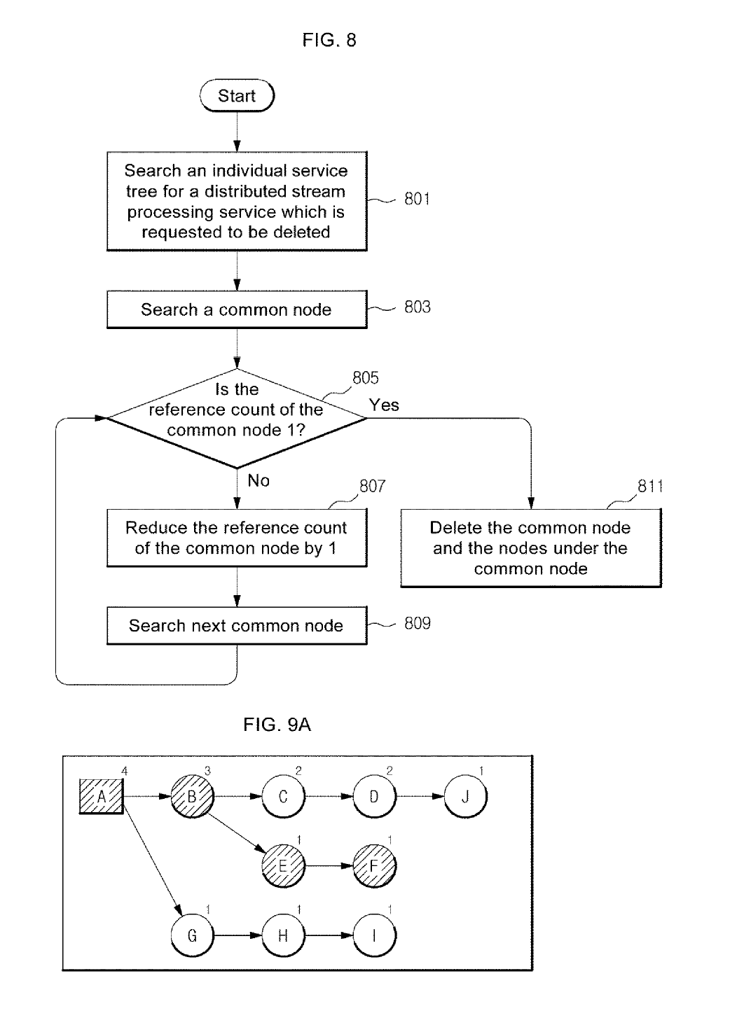

FIG. 8 is a flowchart illustrating an example of a method for deleting a distributed stream processing service from a global service tree. Depending on the embodiment, some of the steps can be omitted or performed in a different order.

In step 801, an apparatus for merging distributed stream processing services may search an individual service tree for a distributed stream processing service which is requested to be deleted from a service tree list by a user.

In step 803, the apparatus for merging distributed stream processing services may search a common node commonly existing in the global service tree and the individual service tree. Searching the common node may be performed sequentially from each highest node of the global service tree and the individual service tree.

In step 805, the apparatus for merging distributed stream processing services may determine whether a reference count of the searched common node is equal to a predetermined value, for example, such as 1.

In step 805, when the reference count of the searched common node is not 1, for example, 2 or above, the apparatus for merging distributed stream processing services may proceed to step 807 to reduce the reference count of the searched common node by 1, and then proceed to step 809 to search a next common node.

When the reference count of the searched common node is 1, it may mean that the common node is a node only used for the distributed stream processing service which is requested to be deleted. Thus, in step 811, the apparatus for merging distributed stream processing services may delete the common node and the nodes under the common node. That is, the apparatus for merging distributed stream processing services may delete the subtree including the common node from the global service tree.

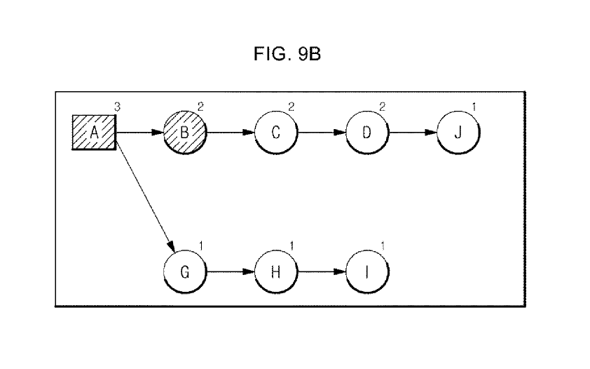

For example, it is assumed that a global service tree is as shown in FIG. 9A and there is a request for deleting a distributed stream processing service including a node flow of A-B-E-F. The apparatus for merging distributed stream processing services may search a common node by sequential comparison from the highest node A and determine a reference count of the searched common node. For example, the reference count of the common node A is 4 which means that the common node A is used for 4 distributed stream processing services. The apparatus for merging distributed stream processing services may reduce the reference count of the common node A by 1 and then search a next common node. This process may be performed sequentially till it searches a common node of which the reference count is 1. For example, as shown in FIG. 9A, it is assumed that the common node E of which the reference count is 1 is searched. The reference count of 1 may mean that the common node E is the node which is used only for the distributed stream processing service which is requested to be deleted. The apparatus for merging distributed stream processing services may delete the common node E and the node F under the common node E from the global service tree as shown in FIG. 9B.

A method for automatic merging distributed stream processing services has been described above. The merging distributed stream processing services may be performed manually by a user. For example, a user may specify a particular node in the global service tree in which specifying may be made using an identifier assigned to each node, and add at least one node under the specified node. The apparatus for merging distributed stream processing services may provide an application programming interface (API) or graphical user interface (GUI) to the user to add the node. When the node is added by the user, the apparatus for merging distributed stream processing services may increase the reference count of the upper nodes of the added node by 1.

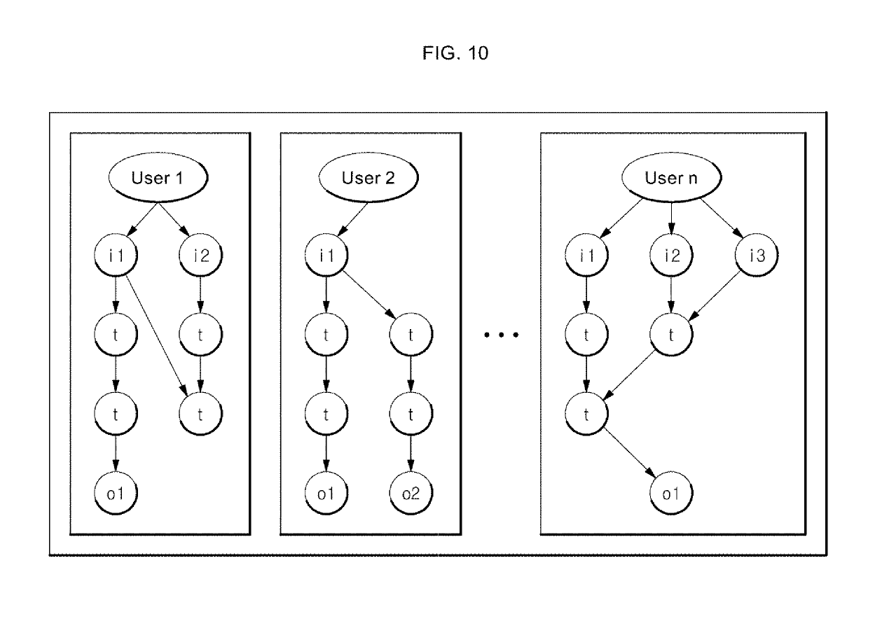

FIG. 10 is a diagram illustrating examples of global service trees for each user. An apparatus for merging distributed stream processing services according to an example may support to share tasks between distributed stream processing services for the same user in order to protect data between users.

For example, as shown in FIG. 10, the global service tree may be managed for each user. Each global service tree may include one root node (user 1, user 2, . . . , user n) and each root node may include multiple input source nodes as child nodes. If needed, the apparatus for merging distributed stream processing services may support to share tasks between distributed stream processing services for different users.

The exemplary embodiment of the present disclosure can be implemented by various method. For example, the exemplary embodiment of the present disclosure can be implemented by using hardware, software or its combination. When they are implemented by software, they may be implemented as software executing in more than one processors using various operating systems or platforms. In addition, the software may be created by using any language among various appropriate programming languages or be compiled in machine language codes or intermediate codes executable in a framework or virtual machine.

In addition, when the exemplary embodiment of the present disclosure is executed in more than one processors, the exemplary embodiment of the present disclosure may be implemented by processor readable media such as a memory, a floppy disk, a hard disk, a compact disk (CD), an optical disk or a magnetic tape, or the like in which more than one programs are recorded to conduct the implementation of various exemplary embodiments of the present disclosure.

What is claimed is:

1. A method for merging distributed stream processing services comprising:
generating a global service tree based on one distributed stream processing service;
when a new distributed stream processing service different from the one distributed stream processing service is inputted, generating an individual service tree for the new distributed stream processing service; and
updating the global service tree by merging at least one node commonly existing in both the global service tree and the individual service tree.

2. The method of claim 1, wherein the updating the global service tree comprises determining whether there are nodes commonly existing in both the global service tree and the individual service tree by comparing with each other sequentially from each highest node of the global service tree and the individual service tree.

3. The method of claim 2, wherein the determining whether there are nodes commonly existing in both the global service tree and the individual service tree comprises determining whether there are a series of common nodes starting from the highest node.

4. The method of claim 3, wherein the updating the global service tree comprises:
determining the lowest node of the series of common nodes as a merging reference node; and
adding a subtree connected under the merging reference node in the individual service tree to under the merging reference node of the global service tree.

5. The method of claim 1, further comprising, when a request for deleting any one distributed stream processing service among the distributed stream processing services reflected to the global service tree is made, updating the global service tree by deleting the node, which is used only for the distributed stream processing service requested to be deleted, from the global service tree.

6. The method of claim 1, further comprising setting a reference count for each node in the global service tree, the reference count representing how many distributed stream processing services use the node.

7. The method of claim 6, further comprising, when there is a node of which the reference count is equal to a predetermined value or above, connecting any one subtree among the subtrees connected under the corresponding node to the upper node of the corresponding node.

8. The method of claim 6, further comprising, when a request for deleting a distributed stream processing service among the distributed stream processing services reflected to the global service tree is made, updating the global service tree by deleting the node which is used only for the corresponding distributed stream processing service from the global service tree.

9. The method of claim 8, wherein the deleting the node from the global service tree comprises:
comparing with each other sequentially from each highest node of the global service tree and an individual service tree for the distributed stream processing service tree requested to be deleted;
when there is a common node of which the reference count is 1, deleting the common node and a subtree connected under the common node; and
when there is a common node of which the reference count is 2 or above, reducing the reference count of the common node by 1.

10. The method of claim 1, further comprising distributing the subtrees in the updated global service tree to different servers.

11. An apparatus for merging distributed stream processing services comprising;
a global service tree manager configured to generate a global service tree based on one distributed stream processing service, generate an individual service tree for a new distributed stream processing service when the new distributed stream processing service different from the one distributed stream processing service is inputted, and update the global service tree by merging at least one node commonly existing in both the global service tree and the individual service tree; and
a scheduler configured to perform resource allocation based on the updated global service tree.

12. The apparatus of claim 11, wherein the global service tree manager compares with each other sequentially from each highest node of the global service tree and the individual service tree to determine whether there are nodes commonly existing in both the global service tree and the individual service tree.

13. The apparatus of claim 12, wherein the global service tree manager determines whether there are a series of common nodes starting from the highest node.

14. The apparatus of claim 13, wherein the global service tree manager determines the lowest node of the series of common nodes as a merging reference node, and adds a subtree connected under the merging reference node in the individual service tree to under the merging reference node of the global service tree.

15. The apparatus of claim 11, wherein when a request for deleting any one distributed stream processing service among the distributed stream processing services reflected to the global service tree is made, the global service tree manager updates the global service tree by deleting the node, which is used only for the distributed stream processing service requested to be deleted, from the global service tree.

16. The apparatus of claim 11, wherein the global service tree manager set a reference count for each node in the global service tree, the reference count representing how many distributed stream processing services use the node.

17. The apparatus of claim 16, wherein when there is a node of which the reference count is equal to a predetermined value or above, the global service tree manager connects any one subtree among the subtrees connected under the corresponding node to the upper node of the corresponding node.

18. The apparatus of claim 16, wherein when a request for deleting a distributed stream processing service among the distributed stream processing services reflected to the global service tree is made, the global service tree manager updates the global service tree by deleting the node, which is used only for the corresponding distributed stream processing service, from the global service tree.

19. The apparatus of claim 18, wherein the global service tree manager compares with each other sequentially from each highest node of the global service tree and an individual service tree for the distributed stream processing service tree requested to be deleted, deletes a common node of which the reference count is 1 and a subtree connected under the common node when there is the common node of which the reference count is 1, and reduces the reference count of a common node of which the reference count is 2 or above by 1 when there is the common node of which the reference count is 2 or above.

20. The apparatus of claim 11, wherein the scheduler distributes the subtrees in the updated global service tree to different servers.
